(19) United States
(12) Patent Application Publication
(10) Pub. No.: US 2007/0294582 A1
(43) Pub. Date: Dec. 20, 2007

(54) Reporting software RAID configuration to system BIOS

(75) Inventors: Madhusudhan Rangarajan, Round Rock, TX (US); Kevin B. Moore, Columbia, SC (US)

Correspondence Address: BAKER BOTTS, LLP, 910 LOUISIANA, HOUSTON, TX, 77002-4995, US

(73) Assignee: Dell Products L.P.

(21) Appl. No.: 11/429,128

(22) Filed: May 5, 2006

(51) Int. Cl. G06F 11/00

(52) U.S. Cl. 714/36

(57) ABSTRACT

An operating system (OS) agent may write information about hard disk drives associated with a software RAID and/or those hard disk drives being boot configured to a non-volatile memory of an information handling system. Then during power on self test (POST) of the information handling system a determination is made whether a software OS RAID hard disk drive control function has been implemented into the OS. Then a comparison of the stored hard disk drive information is made with the presently operating hard disk drives and if there is any discrepancy then a warning message may be displayed indicating that there may be a problem in using the hard disk drives in a software RAID, and/or booting up during POST into the OS of the information handling system.

### TECHNICAL FIELD

The present disclosure relates generally to information handling systems and, more particularly, for checking and reporting on SATA hard disk drives used in software controlled redundant array of independent disks (RAID) of an information handling system.

### BACKGROUND

As the value and use of information continues to increase, individuals and businesses seek additional ways to process and store information. One option available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, multiple disk system and telecommunications switch.

Information handling systems using serial advanced technology attachment (SATA) hard disk drives and redundant array of independent disks (RAID) configurations for these SATA hard disk drives may use software operating system (OS) RAID implementations. In an OS RAID implementation of SATA hard disk drives, an OS driver may handle disk striping, mirroring, etc., depending on the RAID level desired. The basic input-output system (BIOS) of the information handling system may individually configure each SATA hard disk drive making up the RAID system, and may also specify during the information handling system set-up which one of these SATA hard disk drives is chosen for the purpose of booting (starting-up) the information handling system.

### SUMMARY

During POST and Setup of the information handling system, however, there is no information about the OS RAID configuration. If a hard disk drive access sequence, etc., is changed then this may cause an inability to boot (start-up) the information handling system because the BIOS may be trying to obtain boot information from the wrong hard disk drive. Also if a hard disk drive used in the RAID configuration is replaced, removed, or stops functioning, the OS may not be able to reboot, and/or may need to rebuild data stored on the RAID.

According to a specific example embodiment of this disclosure, a method for reporting a configuration of software redundant array of independent disks (RAID) in an information handling system may comprise the steps of: starting a power on self test (POST) of an information handling system; determining whether there is a software operating system (OS) RAID configuration of a plurality of hard disk drives in the information handling system, wherein if not configured then complete POST and boot to an operating system (OS) of the information handling system, and if configured then determining whether each of the plurality of hard disk drives has an identification that matches hard disk drive identifications stored in non-volatile memory of the information handling system, wherein if each of the plurality of hard disk drive identifications matches those identifications stored in the non-volatile memory, then display RAID information, complete POST and boot to the operating system (OS) of the information handling system, and if any one of the plurality of hard disk drive identifications do not match those identifications stored in the non-volatile memory, then display a warning message, complete POST and boot to the operating system (OS) of the information handling system. This method may further comprise the steps of: starting an operating system (OS) agent; determining with the OS agent whether the OS is configured for a software RAID comprising the plurality of hard disk drives; wherein if not configured then ending operation of the OS agent, and if configured then writing to the non-volatile memory the software RAID configuration and the identifications of the plurality of hard disk drives; and ending operation of the OS agent.

According to another specific example embodiment of this disclosure, a method for reporting a configuration of software redundant array of independent disks (RAID) and thereafter determining any change to the reported RAID configuration in an information handling system may comprise the steps of: starting an operating system (OS) agent; determining with the OS agent whether an operating system (OS) of an information handling system is configured for a software RAID comprising a plurality of hard disk drives; wherein if not configured then ending operation of the OS agent, and if configured then writing to a non-volatile memory of the information handling system the software RAID configuration and identifications of the plurality of hard disk drives; and ending operation of the OS agent. The method may further comprise the steps of: starting a power on self test (POST) of the information handling system; determining whether there is a software operating system (OS) RAID configuration of a plurality of hard disk drives in the information handling system, wherein, if not configured then complete POST and boot to an operating system (OS) of the information handling system, and if configured then determining whether each of the plurality of hard disk drives has an identification that matches hard disk drive identifications stored in non-volatile memory of the information handling system, wherein if each of the plurality of hard disk drive identifications matches those identifications stored in the non-volatile memory, then display RAID information, complete POST and boot to the operating system (OS) of the information handling system, and if any one of the plurality of hard disk drive identifications do not match those identifications stored in the non-volatile memory, then display a warning message, complete POST and boot to the operating system (OS) of the information handling system.

According to yet another specific example embodiment of this disclosure, an information handling system having a software redundant array of independent disks (RAID) may comprise: a plurality of serial advanced technology attachment (SATA) hard disk drives in an information handling system; a software operating system (OS) RAID adapted for controlling the plurality of SATA hard disk drives; wherein during a power on self test (POST) of the information handling system a determination is made whether the plurality of hard disk drives are configured for the software operating system (OS) RAID, wherein if not configured then complete POST and boot to an operating system (OS) of the information handling system, and if configured then determining whether each of the plurality of hard disk drives has an identification that matches hard disk drive identifications stored in non-volatile memory of the information handling system, wherein if each of the plurality of hard disk drive identifications matches those identifications stored in the non-volatile memory, then display RAID information, complete POST and boot to the operating system (OS) of the information handling system, and if any one of the plurality of hard disk drive identifications do not match those identifications stored in the non-volatile memory, then display a warning message, complete POST and boot to the operating system (OS) of the information handling system.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of an information handling system, according to a specific example embodiment of the present disclosure;

FIG. 2 is a schematic flow diagram for determining hard disk drive boot and RAID compatibility during power on self test (POST) of the information handling system, according to a specific example embodiment of the present disclosure; and

FIG. 3 is a schematic flow diagram for writing hard disk drive RAID configurations and hard disk drive identification to non-volatile memory of the information handling system, according to a specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific example embodiments are schematically illustrated. Like elements in the drawings will be represented by like numbers, and similar elements will be represented by like numbers with a different lower case letter suffix.

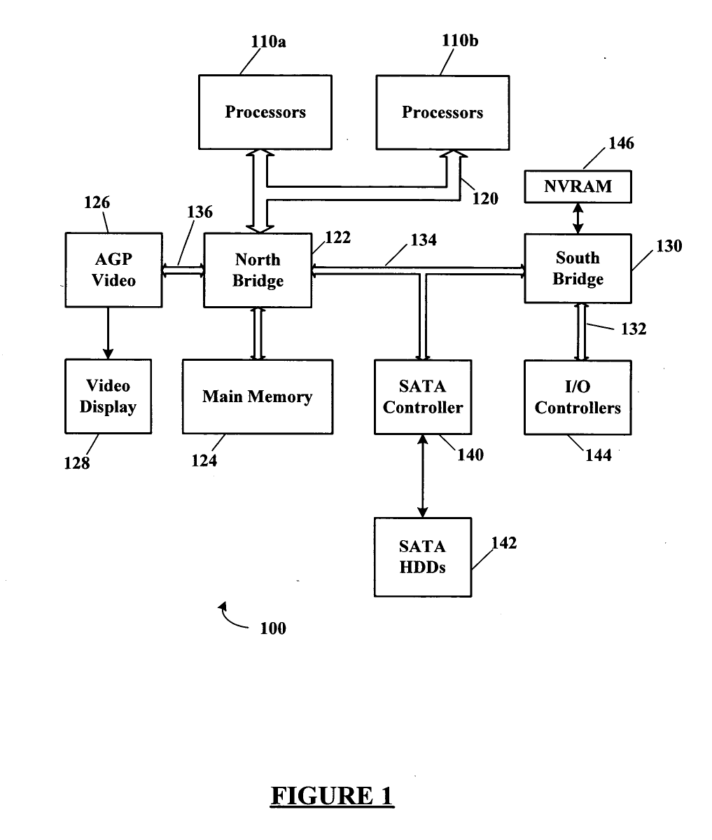

Referring to FIG. 1, depicted is an information handling system having electronic components mounted on at least one printed circuit board (PCB) (motherboard) and communicating data and control signals therebetween over signal buses. In one embodiment, the information handling system is a computer system. The information handling system, generally referenced by the numeral 100, comprises a processor(s) 110 coupled to a host bus(es) 120. A north bridge 122, which may also be referred to as a memory controller hub or a memory controller, is coupled to a main system memory 124. The north bridge 122 is coupled to the system processor(s) 110 via the host bus(es) 120. The north bridge 122 is generally considered an application specific chip set that provides connectivity to various buses, and integrates other system functions such as a memory interface. For example, an Intel 820E and/or 815E chip set, available from the Intel Corporation of Santa Clara, Calif., provides at least a portion of the north bridge 122. The chip set may also be packaged as an application specific integrated circuit (ASIC). The north bridge 122 typically includes functionality to couple the main system memory 124 to other devices within the information handling system 100. Thus, memory controller functions such as main memory control functions typically reside in the north bridge 122. In addition, the north bridge 122 provides bus control to handle transfers between the host bus 120 and a second bus(es), e.g., PCI bus 134, and AGP bus 136. The AGP bus 136 may be coupled to a video graphics interface 126 which drives a video display 128. A second bus(es) 132 may also comprise other industry standard buses or proprietary buses, e.g., ISA, SCSI, USB buses through a south bridge(s) (bus interface) 130. A SATA controller 140 may be coupled to the north bridge 122 or the south bridge 130 (north bridge 122 via bus 134 shown). SATA hard disk drives 142 may be coupled to the SATA controller 140. Other input-output (I/O) controllers 144 may be coupled to the north bridge 122 and/or the south bridge 130 (south bridge 130 via bus 132 shown). A non-volatile memory 146, e.g., CMOS non-volatile random access memory (NVRAM), FLASH memory, etc., may be used to store basic input-output operating system (BIOS) start-up and POST programs, and may also be used for storing tables of information (not shown) more fully described hereinbelow.

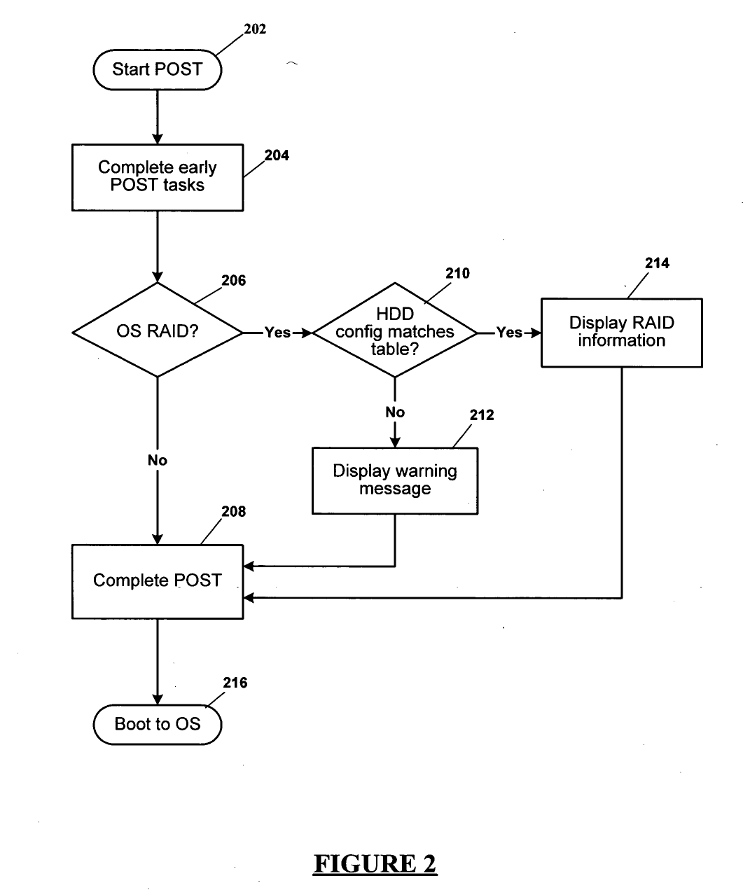

Referring to FIG. 2, depicted is a schematic flow diagram for determining hard disk drive boot and RAID compatibility during power on self test (POST) of the information handling system, according to a specific example embodiment of the present disclosure. In step 202 the information handling system 100 power on self test (POST) starts. During step 204 early POST tasks may be completed. Then in step 206 a determination is made whether a software OS RAID hard disk drive control function has been implemented into the OS of the information handling system 100. If no software OS RAID function is implemented then POST completes in step 208, and in step 216 the operating system (OS) is booted-up so as to operationally run the information handling system 100.

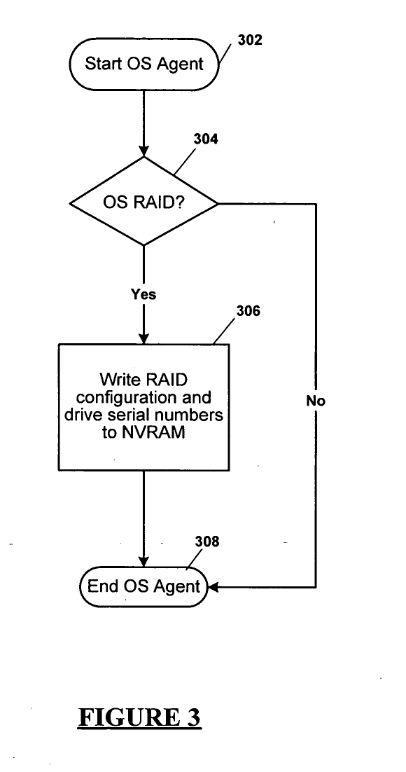

However, if the software OS RAID hard disk drive control function has been implemented into the OS of the information handling system 100, then in step 210 each hard disk drive 142 is checked to determine if they match prior entries (see FIG. 3) in a configuration table located, for example, in the non-volatile memory 146. If the hard disk drives 142 match the entries of the configuration table then in step 214 the RAID information is displayed, and thereafter in step 208 POST completes. However, if there is a mismatch of a disk drive 142 identification and a respective entry in the configuration table, then in step 212 a warning message is displayed, e.g., to a user or administrator, and thereafter in step 208 POST completes.

During step 214, the BIOS may display the RAID information during POST so that the RAID information is available to a user of the information handling system 100. The BIOS may also group the RAID hard disk drives 142 together during setup so that a user may be informed that these hard disk drives 142 are part of a software OS RAID array. However, if a hard disk drive 142 appears to be missing, removed, replace with a new hard disk drive, and/or does not respond, then a warning message indicating a disk problem may be displayed during POST and may also indicate that the software RAID arrays may have to be rebuilt. An occurrence of a missing or replaced hard disk drive 142 may be determined from the hard disk drive identification, e.g., drive serial number, stored in the non-volatile memory 146.

According to the teachings of this disclosure, a user may change boot sequence of the hard disk drives 142, etc., during setup more confidently and without inadvertently creating no-boot issues from boot-up priority selection of a hard disk drive that has not been configured for boot-up service. The user may also be provided with information about the software RAID arrays in the information handling system 100.

Referring to FIG. 3, depicted is a schematic flow diagram for writing hard disk drive RAID configurations and hard disk drive identification to non-volatile memory of the information handling system, according to a specific example embodiment of the present disclosure. In step 302, an OS software agent is started. Then in step 304 a determination is made whether the information handling system 1000S is configured for software RAID operation. If not configured for software RAID operation, then the OS software agent ends in step 308. However, if the OS is configured for software RAID operation, then in step 306 the RAID configuration and hard disk drive identification, e.g., drive serial numbers, may be stored in the non-volatile memory 146. Once this information is stored in the non-volatile memory 146 the OS software agent ends in step 308. Thus, after the OS boots, the software agent may, for example but not limited to, write the port numbers of the hard disk drives 142 associated with the software RAID array, and the serial numbers or any other unique identifier of these hard disk drives 142 into the non-volatile memory 146. It is contemplated and within the scope of this disclosure that the OS software agent may also write additional information, e.g., striping, mirroring, etc., into the non-volatile memory 146 for access by the BIOS during start-up of the information handling system 100.

In is contemplated and within the scope of this disclosure that the aforementioned teachings may also be utilized with hardware RAID implementations for displaying warning messages when a configuration has been changed. Either an option read only memory (ROM) or the BIOS non-volatile memory, e.g., non-volatile memory 146, may also be used according to the teachings of this disclosure.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A method for reporting a configuration of software redundant array of independent disks (RAID) in an information handling system, said method comprising the steps of:
starting a power on self test (POST) of an information handling system;
determining whether there is a software operating system (OS) RAID configuration of a plurality of hard disk drives in the information handling system, wherein
if not configured then complete POST and boot to an operating system (OS) of the information handling system, and
if configured then determining whether each of the plurality of hard disk drives has an identification that matches hard disk drive identifications stored in non-volatile memory of the information handling system, wherein
if each of the plurality of hard disk drive identifications matches those identifications stored in the non-volatile memory, then display RAID information, complete POST and boot to the operating system (OS) of the information handling system, and
if any one of the plurality of hard disk drive identifications do not match those identifications stored in the non-volatile memory, then display a warning message, complete POST and boot to the operating system (OS) of the information handling system.

2. The method according to claim 1, wherein the identifications are serial numbers of the plurality of hard disk drives.

3. The method according to claim 1, wherein the non-volatile memory is complementary metal oxide semiconductor (CMOS) non-volatile (NV) random access memory (RAM).

4. The method according to claim 1, wherein the non-volatile memory is FLASH memory.

5. The method according to claim 1, wherein at least one of the plurality of hard disk drives has the OS program stored therein.

6. The method according to claim 5, wherein the information handling system basic input-output system (BIOS) start-up program retrieves the OS program from the at least one of the plurality of hard disk drives, wherein thereafter the OS runs the information handling system.

7. The method according to claim 1, further comprising the steps of:
starting an operating system (OS) agent;
determining with the OS agent whether the OS is configured for a software RAID comprising the plurality of hard disk drives; wherein
if not configured then ending operation of the OS agent, and
if configured then writing to the non-volatile memory the software RAID configuration and the identifications of the plurality of hard disk drives; and
ending operation of the OS agent.

8. The method according to claim 1, wherein the warning message alerts a user of the information handling system that an operational error has occurred in the software RAID configuration.

9. The method according to claim 1, wherein the warning message alerts a systems administrator of the information handling system that an operational error has occurred in the software RAID configuration.

10. A method for reporting a configuration of software redundant array of independent disks (RAID) and thereafter determining any change to the reported RAID configuration in an information handling system, said method comprising the steps of:
starting an operating system (OS) agent;
determining with the OS agent whether an operating system (OS) of an information handling system is configured for a software RAID comprising a plurality of hard disk drives; wherein
if not configured then ending operation of the OS agent, and
if configured then writing to a non-volatile memory of the information handling system the software RAID configuration and identifications of the plurality of hard disk drives; and
ending operation of the OS agent.

11. The method according to claim 10, further comprising the steps of:
starting a power on self test (POST) of the information handling system;
determining whether there is a software operating system (OS) RAID configuration of a plurality of hard disk drives in the information handling system, wherein,
if not configured then complete POST and boot to an operating system (OS) of the information handling system, and
if configured then determining whether each of the plurality of hard disk drives has an identification that matches hard disk drive identifications stored in non-volatile memory of the information handling system, wherein
if each of the plurality of hard disk drive identifications matches those identifications stored in the non-volatile memory, then display RAID information, complete POST and boot to the operating system (OS) of the information handling system, and
if any one of the plurality of hard disk drive identifications do not match those identifications stored in the non-volatile memory, then display a warning message, complete POST and boot to the operating system (OS) of the information handling system.

12. The method according to claim 10, wherein the identifications are serial numbers of the plurality of hard disk drives.

13. The method according to claim 10, wherein the non-volatile memory is complementary metal oxide semiconductor (CMOS) non-volatile (NV) random access memory (RAM).

14. The method according to claim 10, wherein the non-volatile memory is FLASH memory.

15. The method according to claim 10, wherein at least one of the plurality of hard disk drives has the OS program stored therein.

16. The method according to claim 15, wherein the information handling system basic input-output system (BIOS) start-up program retrieves the OS program from the at least one of the plurality of hard disk drives, wherein thereafter the OS program runs the information handling system.

17. The method according to claim 11, wherein the warning message alerts a user of the information handling system that an operational error has occurred in the software RAID configuration.

18. The method according to claim 11, wherein the warning message alerts a systems administrator of the information handling system that an operational error has occurred in the software RAID configuration.

19. An information handling system having a software redundant array of independent disks (RAID), said system comprising:
a plurality of serial advanced technology attachment (SATA) hard disk drives in an information handling system;
a software operating system (OS) RAID adapted for controlling the plurality of SATA hard disk drives;
wherein during a power on self test (POST) of the information handling system a determination is made whether the plurality of hard disk drives are configured for the software operating system (OS) RAID, wherein
if not configured then complete POST and boot to an operating system (OS) of the information handling system, and
if configured then determining whether each of the plurality of hard disk drives has an identification that matches hard disk drive identifications stored in non-volatile memory of the information handling system, wherein
if each of the plurality of hard disk drive identifications matches those identifications stored in the non-volatile memory, then display RAID information, complete POST and boot to the operating system (OS) of the information handling system, and
if any one of the plurality of hard disk drive identifications do not match those identifications stored in the non-volatile memory, then display a warning message, complete POST and boot to the operating system (OS) of the information handling system.

20. The system according to claim 19 wherein the identifications are serial numbers of the plurality of hard disk drives.

21. The system according to claim 19, wherein the non-volatile memory is complementary metal oxide semiconductor (CMOS) non-volatile (NV) random access memory (RAM).

22. The system according to claim 19, wherein the non-volatile memory is FLASH memory.
